(19) United States
(12) Patent Application Publication
(10) Pub. No.: US 2014/0192969 A1
(43) Pub. Date: Jul. 10, 2014

(54) OPTIMIZED CALL HANDLING FOR RECYCLED TELEPHONE NUMBERS

(71) Applicant: INTERNATIONAL BUSINESS MACHINES CORPORATION, Armonk, NY (US)

(72) Inventors: Gene L. Brown, Durham, CT (US); Clifford V. Harris, Cedar Park, TX (US); Brendan F. Coffey, Rhinebeck, NY (US); Christopher J. Dawson, Arlington, VA (US)

(73) Assignee: International Business Machines Corporation, Armonk, NY (US)

(21) Appl. No.: 13/733,917

(22) Filed: Jan. 4, 2013

(51) Int. Cl. H04M 3/54

(52) U.S. Cl. CPC H04M 3/54
USPC 379/213.01

(57) ABSTRACT

In a method for processing a telephone call, a telephone call originating from a first telephone number and being placed to a second telephone number is intercepted, the second telephone number being previously associated with a telephone service account of a first customer and currently associated with a telephone service account of a second customer. A determination that the first customer is more likely the intended recipient of the telephone call than the second customer is made. Making the determination includes determining that the first telephone number is included at a point in time in a call history of the second telephone number when the second phone number was associated with the telephone service account of the first customer. An action relating to the call is performed in response to the determination that the first customer is more likely the intended recipient of the telephone call than the second customer.

### TECHNICAL FIELD

The present invention relates generally to the field of telecommunication systems, and more particularly to a method, computer program product, and system for optimized call handling for recycled telephone numbers.

### BACKGROUND

Telecommunications systems allow communication over a distance. Fixed-line telecommunication systems generally consist of telephones wired to a local telephone exchange which connects to the public switched telephone network (PSTN).

Cellular mobile communication systems generally comprise of a control station controlling a plurality of radio base stations (RBS) which handle the traffic between mobile devices and network switching systems over a network. The network may be a local area network (LAN), a wide area network (WAN) such as the Internet through Voice over Internet Protocol (VoIP) technology, the PSTN, a private branch exchange (PBX), or any combination thereof. A typical cellular audio voice call is transmitted from a cellular tower near a mobile device to a radio base station and then to the network, from which the call is routed to a control center or telephone exchange near a mobile device which is intended to receive the call.

Telephone numbers are assigned to customers by telecommunications service providers from a pool of available numbers, usually based on the location of the customer. The pool of available numbers consists of both previously used and unused numbers. Newly discarded telephone numbers are typically allowed to age for a period of time before being added to the pool of available numbers to allow for a situation where the original owner of the phone number wants to reclaim the number.

### SUMMARY

A first aspect of the present invention provides a method for processing a telephone call. The method includes intercepting a telephone call originating from a first telephone number and being placed to a second telephone number, the second telephone number being previously associated with a telephone service account of a first customer and currently associated with a telephone service account of a second customer. The method further includes at least one processor determining that the first customer is more likely the intended recipient of the telephone call than the second customer, said determining comprising determining that the first telephone number is included at a point in time in a call history of the second telephone number when the second phone number was associated with the telephone service account of the first customer. The method further includes performing an action relating to the telephone call in response to the at least one processor determining that the first customer is more likely the intended recipient of the telephone call than the second customer.

A second aspect of the present invention provides a computer program product for processing a telephone call. The computer program product includes one or more computer-readable tangible storage devices and program instructions stored on at least one of the one or more storage devices. The program instructions include program instructions to intercept a telephone call originating from a first telephone number and being placed to a second telephone number, the second telephone number being previously associated with a telephone service account of a first customer and currently associated with a telephone service account of a second customer. The program instructions further include program instructions to determine that the first customer is more likely the intended recipient of the telephone call than the second customer, said program instructions to determine that the first customer is more likely the intended recipient of the telephone call than the second customer comprise program instructions to determine that the first telephone number is included at a point in time in a call history of the second telephone number when the second phone number was associated with the telephone service account of the first customer. The program instructions further include program instructions to perform an action relating to the telephone call in response to the determination that the first customer is more likely the intended recipient of the telephone call than the second customer.

A third aspect of the present invention provides a computer system for processing a telephone call. The computer system includes one or more processors, one or more computer-readable memories, one or more computer-readable tangible storage devices and program instructions which are stored on at least one of the one or more storage devices for execution by at least one of the one or more processors via at least one of the one or more memories. The program instructions include program instructions to intercept a telephone call originating from a first telephone number and being placed to a second telephone number, the second telephone number being previously associated with a telephone service account of a first customer and currently associated with a telephone service account of a second customer. The program instructions further include program instructions to determine that the first customer is more likely the intended recipient of the telephone call than the second customer, said program instructions to determine that the first customer is more likely the intended recipient of the telephone call than the second customer comprise program instructions to determine that the first telephone number is included at a point in time in a call history of the second telephone number when the second phone number was associated with the telephone service account of the first customer. The program instructions further include program instructions to perform an action relating to the telephone call in response to the determination that the first customer is more likely the intended recipient of the telephone call than the second customer.

### BRIEF DESCRIPTION OF THE SEVERAL VIEWS OF THE DRAWINGS

FIG. 1 is a functional block diagram illustrating a computing system, in accordance with one embodiment of the present invention.

FIG. 2 depicts a use-case scenario in accordance with one embodiment of the present invention.

FIG. 3 depicts a flowchart of processing a telephone call in accordance with one embodiment of the present invention.

FIG. 4 depicts a block diagram of components of a provider server in accordance with one embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

Embodiments of the present invention recognize that when a second telecommunications customer acquires a telephone number which was formerly associated with a first telecommunications customer, the second customer will most likely receive calls meant for the first customer (and the first customer will be missing calls) for some time after the second customer acquires the telephone number. Embodiments of the present invention address this situation by using analytics to determine whether the first customer is more likely than the second customer to be the intended recipient of a telephone call to the telephone number. The present invention will now be described in detail with reference to the Figures.

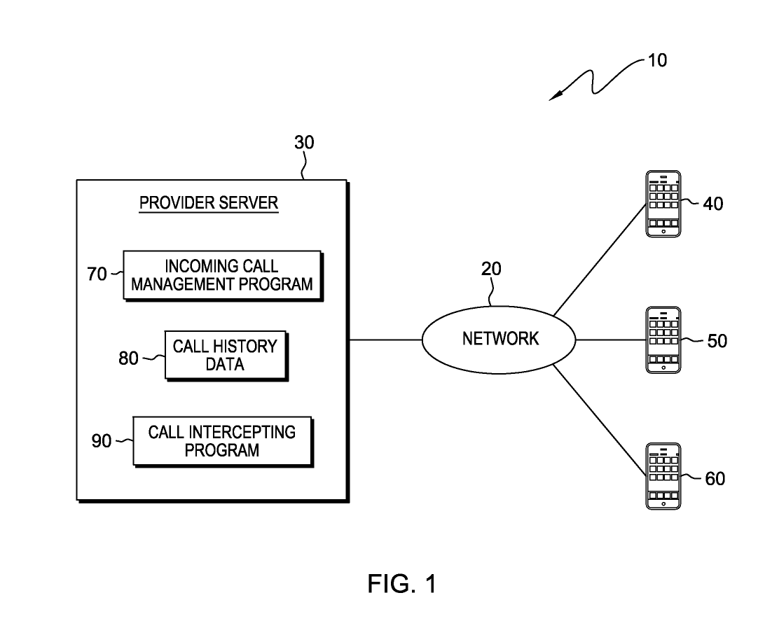

FIG. 1 is a functional block diagram illustrating a computing system 10, in accordance with one embodiment of the present invention. FIG. 1 provides only an illustration of one embodiment and does not imply any limitations with regard to the environments in which different embodiments may be implemented.

In the depicted embodiment, computing system 10 includes a provider server 30 and telephones 40, 50, and 60 interconnected over a network 20. Network 20 may be a LAN, a WAN such as the Internet, the PSTN, a PBX, any combination thereof, or any combination of connections and protocols that will support communications between provider server 30 and telephones 40, 50, and 60 in accordance with embodiments of the invention. Network 20 may include wired, wireless, or fiber optic connections. Computing system 10 may include additional servers, telephones, or other devices not shown.

Telephones 40, 50, and 60 may be plain old telephone service (POTS) telephones, VoIP telephones, cellular telephones, smart phones, or computers implementing a telephony application. In general, telephones 40, 50, and 60 may each be any device or computing system capable of transmitting voice and caller identification (caller ID) data to provider server 30 over network 20. Caller ID data may include at least the caller's telephone number, and additionally may include the caller's name.

Provider server 30 may be a management server, a web server, a web share, or any device or computing system capable of receiving and sending data. In other embodiments, provider server 30 may represent a server computing system utilizing multiple computers as a server system such as in a cloud computing environment. Provider server 30 includes an incoming call management program 70, call history data 80, and a call intercepting program 90.

Incoming call management program 70 operates to receive, forward, and manage telephone calls between two or more of telephones 40, 50, and 60. Incoming call management program 70 may also save telephone call information to call history data 80. Telephone call information may include, but is not limited to, caller ID data and a dialed telephone number. In one embodiment, incoming call management program 70 resides on provider server 30. In other embodiments, incoming call management program 70 may reside on another server or computing device, provided that incoming call management program 70 can communicate with telephones 40, 50, and 60, and call intercepting program 90, and provided that incoming call management program 70 has access to call history data 80.

In one embodiment, an incoming telephone call is intercepted by call intercepting program 90. The incoming telephone call may include telephone call information associated with the incoming telephone call. In one embodiment, call intercepting program 90 determines if the dialed telephone number was, within a prescribed time frame (e.g., 3 months, 6 months, or one year), associated with a telephone service account of a different telecommunications customer than a telephone service account of a telecommunications customer currently associated with the dialed telephone number. If the dialed telephone number was, within a prescribed time frame (e.g., 3 months, 6 months, or one year), associated with the telephone service account of the different telecommunications customer than the telephone service account of the telecommunications customer currently associated with the dialed telephone number, call intercepting program 90 proceeds. If the dialed telephone number was not, within a prescribed time frame (e.g., 3 months, 6 months, or one year), associated with the telephone service account of the different telecommunications customer than the telephone service account of the telecommunications customer currently associated with the dialed telephone number, call intercepting program 90 sends the telephone call to incoming call management program 70 for normal processing.

Call history data 80 may be stored in a repository that may be written and read by incoming call management program 70 and may be accessible to call intercepting program 90. For example, call history data 80 may be stored in a database such as an Oracle® or an IBM® DB2® database.

In one embodiment, call history data 80 includes a call history associated with all telephone numbers managed by incoming call management program 70. Incoming call management program 70 may be utilized by a telecommunications service provider. The call history may be a list of all incoming and dialed numbers associated with each number managed by incoming call management program 70. In another embodiment, call history data 80 may also include an address book associated with each telephone number managed by incoming call management program 70.

Call history data 80 may also include a record of the telecommunications customer accounts associated with each telephone number managed by incoming call management program 70. The record may include the name of every telecommunications customer associated with a telephone number. The record may also include the dates when each associated telecommunications customer was associated with the telephone number. The dates when each associated telecommunications customer was associated with the telephone number may include the date on which the telecommunications customer began being associated with the telephone number and the date on which the telecommunications customer ceased being associated with the telephone number.

In another embodiment, call history data 80 may also include an address book of a telecommunications customer when the telecommunications customer was associated with a telephone number managed by incoming call management program 70. The address book may include a record indicating the dates when the telecommunications customer was associated with the telephone number. The dates when the telecommunications customer was associated with the telephone number may include the date on which the telecommunications customer began being associated with the telephone number and the date on which the telecommunications customer ceased being associated with the telephone number.

Call intercepting program 90 operates to determine that an incoming telephone call to a telephone number previously associated with a telephone service account of a first customer and currently associated with a telephone service account of a second customer is more likely meant for the first customer than the second customer. In one embodiment, call intercepting program 90 resides on provider server 30. In other embodiments, call intercepting program 90 may reside on another server, computing device, or telephone, provided that call intercepting program 90 can communicate with incoming call management program 70 and telephones 40, 50 and 60, and call intercepting program 90 has access to call history data 80. In other embodiments, call intercepting program 90 may be part of or reside in another program, such as incoming call management program 70.

In one embodiment, call intercepting program 90 receives telephone call information, including caller ID data and the dialed telephone number, of an incoming telephone call. Call intercepting program 90 checks if the caller ID data exists in a portion or portions of call history data 80 including the call history of the dialed telephone number when the dialed telephone number was associated with the first customer. In the event that the caller ID data is present in the call history, call intercepting program 90 may determine that the incoming telephone call is more likely meant for the first customer than the second customer and may perform an action relating to the incoming telephone call in response.

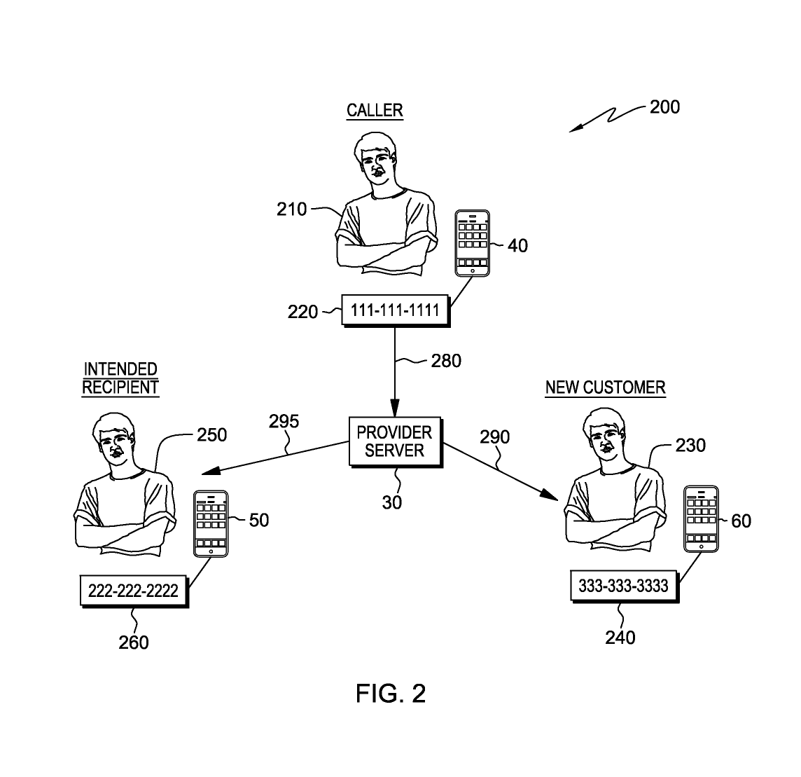

FIG. 2 depicts a use-case scenario 200 in accordance with one embodiment of the present invention. Scenario 200 depicts a telecommunications customer, caller 210, with telephone number 220 (herein referred to as “the caller's number”) of telephone 40 attempting to reach another telecommunications customer, intended recipient 250. A telephone service account of intended recipient 250 is currently associated with telephone number 260 (herein referred to as “intended recipient's new number”) of telephone 50, but was previously associated with telephone number 240 of telephone 60.

Scenario 200 also depicts a new telecommunications customer 230. A telephone service account of new telecommunications customer 230 is currently associated with telephone number 240 (herein referred to as “intended recipient's original number”). Provider server 30, utilizing call intercepting program 90, may act as the interface between caller 210, intended recipient 250, and new customer 230.

In scenario 200, caller 210 is attempting to call intended recipient 250 by placing call 280 via network 20. Telephone call information of call 280 includes caller ID data, including telephone number 220, and dialed telephone number 240. In response to intercepting call 280, call intercepting program 90 may check, in call history data 80, the call history of dialed telephone number 240 when dialed telephone number 240 was previously associated with the telephone service account of intended recipient 250 to determine whether call 280 is more likely meant for intended recipient 250 than new customer 230. In the case that call intercepting program 90 finds the caller ID data in the call history of dialed telephone number 240 when dialed telephone number 240 was associated with the telephone service account of intended recipient 250, call intercepting program 90 may determine that call 280 is more likely meant for intended recipient 250 than new customer 230. In response to call intercepting program 90 determining that call 280 is more likely meant for intended recipient 250 than new customer 230, call intercepting program 90 may perform an action relating to call 280. In one embodiment, the action may be forwarding call 280 to telephone number 260 instead of dialed telephone number 240 (designated in FIG. 2 as forwarded call 295). In the case that call intercepting program 90 does not find the caller ID data in the call history of dialed telephone number 240 when dialed telephone number 240 was associated with the telephone service account of intended recipient 250, call intercepting program 90 may determine that call 280 is more likely meant for new customer 230, and call intercepting program 90 may therefore direct the call to incoming call management program 70, which forwards call 280 to dialed telephone number 240 (designated in FIG. 2 as direct call 290).

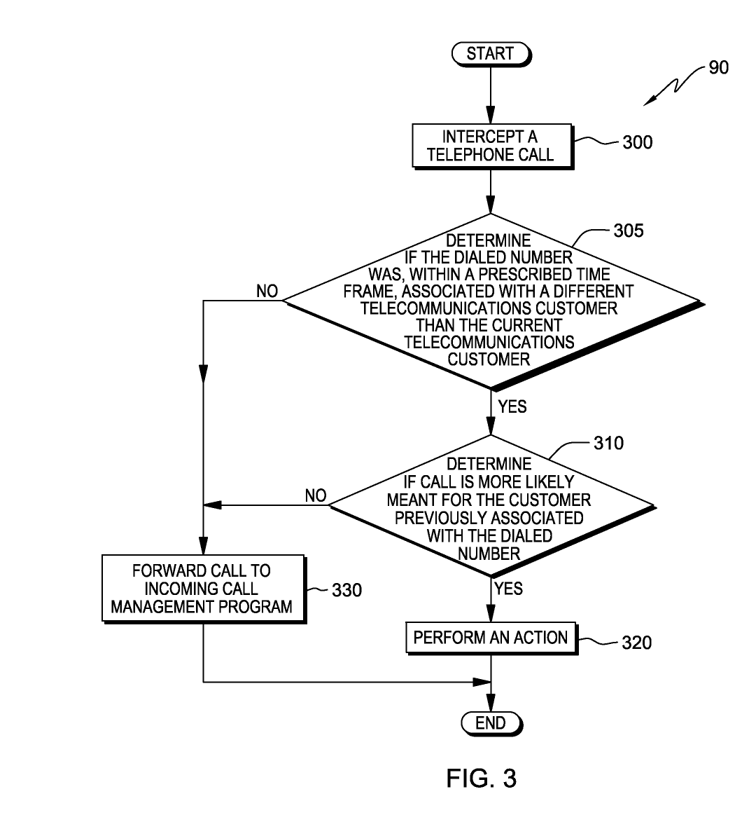

FIG. 3 depicts a flowchart of processing a telephone call in accordance with one embodiment of the present invention. In step 300, call intercepting program 90 intercepts call 280 originating from telephone number 220 and being placed to dialed telephone number 240, dialed telephone number 240 being previously associated with a telephone service account of intended recipient 250 and currently associated with a telephone service account of new customer 230.

In decision 305, call intercepting program 90 determines if dialed telephone number 240 was, within a prescribed time frame (e.g., 3 months, 6 months, or one year), associated with the telephone service account of a different telecommunications customer than the telephone service account of the telecommunications customer currently associated with the dialed telephone number. In one embodiment, call intercepting program 90 determines if dialed telephone number 240 was, within a prescribed time frame (e.g., 3 months, 6 months, or one year), associated with the telephone service account of intended recipient 250 and not the telephone service account of new customer 230. Call intercepting program 90 access call history data 80 to determine when dialed telephone number 240 was associated with the telephone service account of intended recipient 250. Call history data 80 contains a record of the telecommunications customer accounts associated with dialed telephone number 240 and when the different telecommunications customer accounts were associated with dialed telephone number 240.

If call intercepting program 90 determines that dialed telephone number 240 was, within a prescribed time frame (e.g., 3 months, 6 months, or one year), associated with a different telecommunications customer than a telephone service account of a telecommunications customer currently associated with the dialed telephone number (decision 305, yes branch), call intercepting program 90 continues to decision 310.

If call intercepting program 90 determines that dialed telephone number 240 was not, within a prescribed time frame (e.g., 3 months, 6 months, or one year), associated with a different telecommunications customer than a telephone service account of a telecommunications customer currently associated with the dialed telephone number (decision 305, yes branch), call intercepting program 90 continues to step 330.

Call intercepting program 90 determines if call 280 is more likely meant for intended recipient 250 than new customer 230 (decision 310).

In one embodiment, call intercepting program 90 accesses call history data 80 to determine whether the caller ID data of call 280 exists in the call history of dialed telephone number 240 when dialed telephone number 240 was associated with the telephone service account of intended recipient 250. For example, call intercepting program 90 may check if the call history from call history data 80 associated with dialed telephone number 240 includes the number, name, or both of caller 210. For example, if the call history of dialed telephone number 240 (i.e. ‘333-333-3333’) when dialed telephone number 240 was associated with the telephone service account of intended recipient 250 includes the name or telephone number of caller 210 (i.e. ‘111-111-1111’), call intercepting program 90 determines that caller 210 is more likely trying to reach intended recipient 250. The telephone service account of intended recipient 250 is now associated with telephone number 260 (i.e. ‘222-222-2222’). In contrast, if the call history of dialed telephone number 240 (i.e. ‘333-333-3333’) when dialed telephone number 240 was associated with the telephone service account of intended recipient 250 does not include the name or telephone number of caller 210 (i.e. ‘111-111-1111’), call intercepting program 90 determines that caller 210 is not more likely trying to reach intended recipient 250. The telephone service account of intended recipient 250 is now associated with telephone number 260 (i.e. ‘222-222-2222’). In another embodiment, call intercepting program 90 checks call history data 80 to determine whether the caller ID data exists in the address book of dialed telephone number 240 when dialed telephone number 240 was associated with the telephone service account of intended recipient 250. For example, call intercepting program 90 may check if the address book from call history data 80 associated with dialed telephone number 240 includes the number, name, or both of caller 210. For example, if the address book of dialed telephone number 240 (i.e. ‘333-333-3333’) when dialed telephone number 240 was associated with the telephone service account of intended recipient 250 includes the name or telephone number of caller 210 (i.e. ‘111-111-1111’), call intercepting program 90 determines that caller 210 is more likely trying to reach intended recipient 250. The telephone service account of intended recipient 250 is now associated with telephone number 260 (i.e. ‘222-222-2222’).

If call intercepting program 90 determines that call 280 is more likely meant for the intended recipient 250 than new customer 230 (decision 310, yes branch), call intercepting program 90 performs an action (step 320) described below.

For example, in one embodiment, call intercepting program 90 performs an action (step 320) by terminating call 280. In another embodiment, call intercepting program 90 sends an indication to incoming call management program 70 to terminate call 280.

Further, in one embodiment call intercepting program 90 performs an action (step 320) by connecting call 280 to telephone number 260. In another embodiment, call intercepting program 90 sends an indication to incoming call management program 70 to connect call 280 to telephone number 260.

Further still, in one embodiment, call intercepting program 90 performs an action (step 320) by notifying the telecommunications service provider of the telephone service account of intended recipient 250 that call 280 was placed to dialed telephone number 240 (e.g., the original number of intended recipient 250). For example, call intercepting program 90 sends an indication to the telecommunications service provider of the telephone service account of intended recipient 250. The notifying may be done in accordance with privacy regulations, customer preference, an agreement between telecommunications service providers of the telephone service account of new customer 230 and the telephone service account of intended recipient 250, or any combination thereof. In another embodiment, call intercepting program 90 sends an indication to incoming call management program 70 to notify the telecommunications service provider of the telephone service account of intended recipient 250 that a telephone call (call 280) was placed to dialed telephone number 240 (e.g., the original number of intended recipient 250). For example, incoming call management program 70 sends an indication to the telecommunications service provider of intended recipient 250. The notifying may be done in accordance with privacy regulations, customer preference, an agreement between telecommunications service providers of the telephone service account of new customer 230 and the telephone service account of intended recipient 250, or any combination thereof.

Further, in one embodiment, call intercepting program 90 performs an action (step 320) by sending a notification to telephone 40 of caller 210 that the telephone service account of intended recipient 250 is no longer associated with dialed telephone number 240. The notification may be in the form of an audio message played to telephone 40 of caller 210, a text message sent to telephone 40 of caller 210, or a combination thereof. The notification may be done in accordance with privacy regulations, customer preference, an agreement between telecommunications service providers of the telephone service account of new customer 230 and the telephone service account of intended recipient 250, or any combination thereof. In another embodiment, call intercepting program 90 sends an indication to incoming call management program 70 to notify telephone 40 of caller 210 that the telephone service account of intended recipient 250 is no longer associated with dialed telephone number 240. The notification may be in the form of an audio message played to telephone 40 of caller 210, a text message sent to telephone 40 of caller 210, or a combination thereof. The notification may be done in accordance with privacy regulations, customer preference, an agreement between telecommunications service providers of the telephone service account of new customer 230 and the telephone service account of intended recipient 250, or any combination thereof.

If call intercepting program 90 determines that call 280 is more likely meant for the new customer 230 than intended recipient 250 (decision 310, no branch), call intercepting program 90 forwards call 280 to incoming call management program 70. Incoming call management program 70 can then forward call 280 to dialed telephone number 240 (step 330).

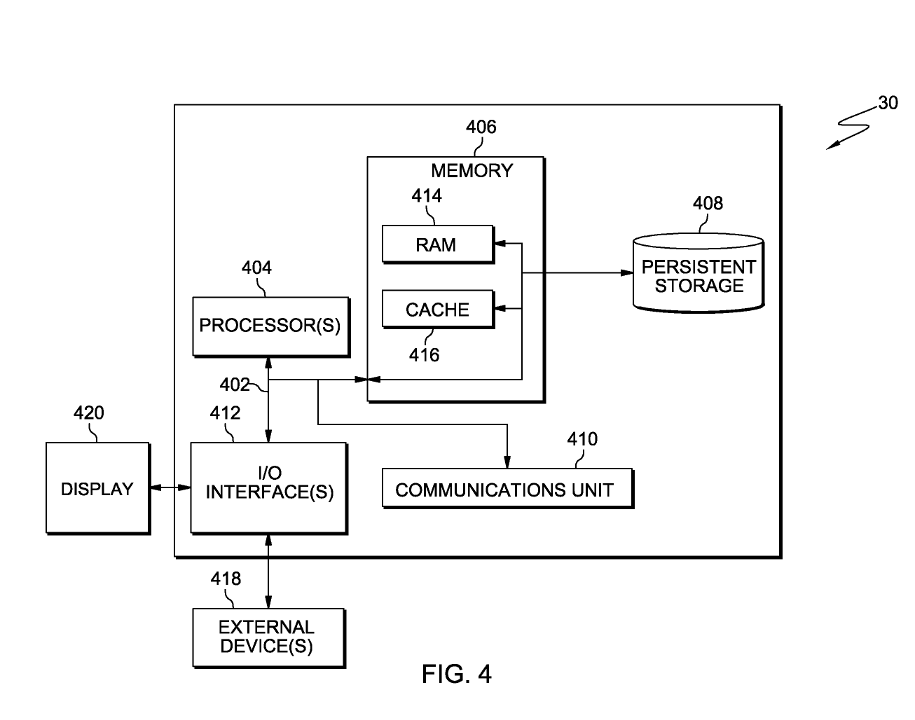

FIG. 4 depicts a block diagram of components of provider server 30 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Provider server 30 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Incoming call management program 70, call history 80, and call intercepting program 90 are stored in persistent storage 408. Incoming call management program 70 and call intercepting program 90 can be executed and/or accessed by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including telephones 40, 50 and 60. In these examples, communications unit 410 includes one or more network interface cards. Communications unit 410 may provide communications through the use of either or both physical and wireless communications links. Incoming call management program 70, call history 80, and call intercepting program 90 may be downloaded to persistent storage 408 through communications unit 410.

I/O interface(s) 412 allows for input and output of data with other devices that may be connected to provider server 30. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., incoming call management program 70, call history 80, and call intercepting program 90, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for processing a telephone call, the method comprising the steps of:
intercepting a telephone call originating from a first telephone number and being placed to a second telephone number, the second telephone number being previously associated with a telephone service account of a first customer and currently associated with a telephone service account of a second customer;
at least one processor determining that the first customer is more likely the intended recipient of the telephone call than the second customer, said determining comprising determining that the first telephone number is included at a point in time in a call history of the second telephone number when the second phone number was associated with the telephone service account of the first customer; and
in response to the at least one processor determining that the first customer is more likely the intended recipient of the telephone call than the second customer, performing an action relating to the telephone call.

2. The method of claim 1, wherein the step of the at least one processor determining that the first customer is more likely the intended recipient of the telephone call than the second customer further comprises determining that the first telephone number was included in an address book of the second telephone number while the second phone number was associated with the telephone service account of the first customer.

3. The method of claim 1, wherein the action comprises terminating the telephone call.

4. The method of claim 1, wherein the action comprises connecting the telephone call to a third number currently associated with the telephone service account of the first customer.

5. The method of claim 1, wherein the action comprises notifying a telephone service provider of the telephone call, the telephone service provider being associated with the telephone service account of the first customer.

6. The method of claim 5, wherein the notifying is performed in accordance with a privacy regulation.

7. The method of claim 5, wherein the notifying is performed according to an agreement between the telephone service provider associated with the telephone service account of the first customer and a telephone service provider associated with the telephone service account of the second customer.

8. The method of claim 5, wherein the notifying is performed according to a user preference.

9. A computer program product for processing a telephone call, the computer program product comprising:
one or more computer-readable tangible storage devices and program instruction stored on at least one of the one or more storage devices, the program instructions comprising:
program instructions to intercept a telephone call originating from a first telephone number and being placed to a second telephone number, the second telephone number being previously associated with a telephone service account of a first customer and currently associated with a telephone service account of a second customer;
program instructions to determine that the first customer is more likely the intended recipient of the telephone call than the second customer, said program instructions to determine that the first customer is more likely the intended recipient of the telephone call than the second customer comprising program instructions to determine that the first telephone number is included at a point in time in a call history of the second telephone number when the second phone number was associated with the telephone service account of the first customer; and
program instructions to perform an action relating to the telephone call in response to a determination that the first customer is more likely the intended recipient of the telephone call than the second customer.

10. The computer program product of claim 9, wherein the program instructions to determine that the first customer is more likely the intended recipient of the telephone call than the second customer further comprise program instructions to determine that the first telephone number was included in an address book of the second telephone number while the second phone number was associated with the telephone service account of the first customer.

11. The computer program product of claim 9, wherein the action comprises terminating the telephone call.

12. The computer program product of claim 9, wherein the action comprises connecting the telephone call to a third number currently associated with the telephone service account of the first customer.

13. The computer program product of claim 9, wherein the action comprises notifying a telephone service provider of the telephone call, the telephone service provider being associated with the telephone service account of the first customer.

14. The computer program product of claim 13, wherein the notifying is performed in accordance with a privacy regulation.

15. A computer system for processing a telephone call, the computer system comprising:
one or more processors, one or more computer-readable memories, one or more computer-readable tangible storage devices and program instructions which are stored on at least one of the one or more storage devices for execution by at least one of the one or more processors via at least one of the one or more memories, the program instructions comprising:
program instructions to intercept a telephone call originating from a first telephone number and being placed to a second telephone number, the second telephone number being previously associated with a telephone service account of a first customer and currently associated with a telephone service account of a second customer;
program instructions to determine that the first customer is more likely the intended recipient of the telephone call than the second customer, said program instructions to determine that the first customer is more likely the intended recipient of the telephone call than the second customer comprising program instructions to determine that the first telephone number is included at a point in time in a call history of the second telephone number when the second phone number was associated with the telephone service account of the first customer; and
program instructions to perform an action relating to the telephone call in response to a determination that the first customer is more likely the intended recipient of the telephone call than the second customer.

16. The computer system of claim 15, wherein the program instructions to determine that the first customer is more likely the intended recipient of the telephone call than the second customer further comprise program instructions to determine that the first telephone number was included in an address book of the second telephone number while the second phone number was associated with the telephone service account of the first customer.

17. The computer system of claim 15, wherein the action comprises terminating the telephone call.

18. The computer system of claim 15, wherein the action comprises connecting the telephone call to a third number currently associated with the telephone service account of the first customer.

19. The computer system of claim 15, wherein the action comprises notifying a telephone service provider of the telephone call, the telephone service provider being associated with the telephone service account of the first customer.

20. The computer system of claim 15, further comprising program instructions, stored on at least one of the one or more storage devices for execution by at least one of the one or more processors via at least one of the one or more memories, to determine that the second telephone number was, within a prescribed time frame, associated with the telephone service account of the first customer.
